(19) United States
(12) Patent Application Publication
(10) Pub. No.: US 2002/0194011 A1
(43) Pub. Date: Dec. 19, 2002

(54) Apparatus, method and computer program product for selecting a format for presenting information content based on limitations of a user

(75) Inventors: Stephen J. Boies, Mahopac, NY (US); Samuel H. Dinkin, Austin, TX (US); Paul Andrew Moskowitz, Yorktown Heights, NY (US); Philip S. Yu, Chappaqua, NY (US); William Grey, Millwood, NY (US); David Perry Greene, Ossining, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/884,580

(22) Filed: Jun. 19, 2001

(51) Int. Cl. G06F 17/60; G06F 15/16

(52) U.S. Cl. 705/1; 709/246

(57) ABSTRACT

An apparatus, method and computer program product are provided for automatically determining the limitations of an individual for receiving and interpreting information and then providing information content to the individual in a format that is understandable to the individual. The apparatus, method and computer program product make use of a mechanism for identifying the limitations of the individual. The mechanism may itself inform an information source of the limitations of the individual or the mechanism may be used in conjunction with a user profile to identify the limitations of the individual and the preferred information content format to use with the individual. Based on this determination, a format for the information content from the information source may be selected and used to output the information content to the individual. The selection of the format may include enhancing one or more aspects of a standard format and decreasing one or more other aspects of the standard format.

### BACKGROUND OF THE INVENTION

1. Technical Field

The present invention is directed to an apparatus, method and computer program product for selecting a format for presenting information content based on limitations of a user.

2. Description of Related Art

The ability to communicate with people is essential in today's information age. Communication often requires that the persons involved in the communication be aware of the limitations of the other persons involved in the communication to receive and interpret the various types of communication formats.

For example, if a person is hearing impaired, speaking to the person using verbal communication will not be the best format for conveying information to that person. Similarly, if a person is blind, standard written communication will not be the best format for conveying information to that person. In the same way that a hearing impaired person cannot receive and interpret information verbally, a person who speaks a different language from that of another person may find it difficult or impossible to communicate verbally.

In order to accommodate persons having various limitations on their ability to receive and interpret information, information is typically offered in a variety of formats and the choice of which format to use is left to the individual having the limitation. For example, a person who is hearing impaired will use closed captioning feeds of television programs to gain an understanding of what is being said. A person who is blind may make use of Braille books. A person who speaks Spanish rather than English may read only Spanish language newspapers, books, watch Spanish language television channels, and speak only with other Spanish speaking individuals.

There are many problems associated with the prior art manner of handling information limitations of various individuals. Even though information content may be provided in a number of different formats, e.g. Braille, closed captioning, various languages, and the like, not all information content is available in every possible format. Thus, some individuals that have particular limitations in their ability to receive and interpret information may not be able to find a source for the information content in a format they can use. For example, there may not be a version of a particular television program that is closed captioned.

While information content is provided in a number of different formats, the selection of the format is left to the individual each time the individual wishes to obtain information. Thus, the individual must search out and find information that is available in the format that he/she can receive and interpret. There is no automatic way of determining the limitations of the individual to thereby provide the information content in the format that is comprehensible by the individual.

### SUMMARY OF THE INVENTION

The present invention provides an apparatus, method and computer program product for automatically determining the limitations of an individual for receiving and interpreting information and then providing information content to the individual in a format that is understandable to the individual. The apparatus, method and computer program product make use of a mechanism for identifying the limitations of the individual. The mechanism may be a wireless transmitter, a smartcard, a magnetic stripe card, a Bluetooth™ enabled device, a biological feature identification device, or the like.

The mechanism may itself inform an information source of the limitations of the individual or the mechanism may be used in conjunction with a user profile to identify the limitations of the individual and the preferred information content format to use with the individual.

Based on this determination, a format for the information content from the information source may be selected and used to output the information content to the individual. The selection of the format may include enhancing one or more aspects of a standard format and decreasing one or more other aspects of the standard format. For example, if an information content includes video and audio information and the individual is visually impaired, the information content format may be adjusted to turn off the video information and enhance the audio information of the information content. Similarly, if the individual is hearing impaired, the video information may be enhanced while the audio information is reduced or turned off. Other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram illustrating a distributed data processing system according to the present invention;

FIG. 2 is an exemplary block diagram illustrating an information source according to the present invention; and

FIG. 3 is an exemplary block diagram illustrating an information retrieval device according to the present invention;

FIG. 4 is an exemplary block diagram illustrating the primary operational components of the information retrieval device according to the present invention;

FIG. 5 is an exemplary block diagram illustrating the primary operational components of the information source according to the present invention; and

FIG. 6 is a flowchart outlining an exemplary operation of an information retrieval device according to the present invention.

### DETAILED DESCRIPTION OF THE PREFERRED EMBODIMENT

FIG. 1 is an exemplary block diagram illustrating a distributed data processing system in accordance with the present invention. As shown in FIG. 1, the distributed data processing system 100 includes an identification device 110, a information content retrieval device 120, one or more networks 130, and one or more information sources 140-160. The one or more networks 130 provide a communication medium by which the information content retrieval device 120 and the one or more information sources 140-160 may send and receive control messages and data.

The information sources 140-160 may be any type of device capable of providing information content in one or more various formats. For example, the information sources 140-160 may be network servers, databases, television or radio stations, information pager service supplier systems, and the like [INVENTORS: PLEASE ADD TO THE LIST AS YOU SEE FIT]. In a preferred embodiment of the present invention, the information sources 140-160 are servers that provide information content in one or more of textual format, graphical and/or video format, and audio format. The information from information suppliers 140-160 is supplied to information content retrieval device 120 via the one or more networks 130 in the form of data transmissions.

The one or more networks 130 may be any type of network capable of conveying information from an information source to an information content retrieval device 120. The one or more networks 130 are the medium used to provide communications links between various devices and computers connected together within distributed data processing system 100. The one or more networks 130 may include connections, such as wired communication links, wireless communication links, satellite communication links, cellular or similar radio based communication links, infrared communication links, fiber optic cables, coaxial cables, and the like.

The one or more networks 130 may include a local area network (LAN), wide area network (WAN), intranet, satellite network, infrared network, radio network, cellular telephone network or other type of wireless communication network, the Internet, and the like. The one or more networks 130 may further be a bus or hub that allows communication between different devices within a local area network or within a single device. For example, the information content retrieval device 120 and the information sources 140-160 may be housed in a single device and may be coupled to one another via a bus, bridge, or the like, that comprises network 130.

In the depicted example, network data processing system 100 is the Internet with the one or more networks 130 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages.

The information content retrieval device 120 may be any device capable of receiving input from an identification device 110, sending information content request messages to information sources 140-160, and providing the information content as output to a user of the identification device 110. The information content retrieval device 120 may be a computer, a workstation, a kiosk, a computerized television device, a computerized radio transmission receiving device, and the like. In a preferred embodiment of the present invention, the information content retrieval device 120 is a computer.

The information content retrieval device 120 receives identification information from the identification device 110 and sends a request for information content to an appropriate information source 140-160 based on the identification information and an information content selection of a user of the identification device 110. The identification device 110 may be embodied in a plurality of different devices including a personal digital assistant (PDA), a smartcard, a wireless transmitter, a two-way pager device, a BluetoothT™ enabled device, a wearable computer, and the like. The identification device 110 may be equipped with output and/or input interfaces for outputting information content and receiving selections from a user, respectively. Furthermore, the identification device 110 may be a device that is installed in a vehicle or other apparatus used by the user rather than a personal device such as those described above. In a preferred embodiment, the identification device 110 is a wireless transmitter that is programmed with identification information of a user.

The user of the identification device 110 is a user having some type of information receipt and interpretation limitation. The information receipt and interpretation limitation may be, for example, loss of hearing, blindness or other vision loss, inability to speak the common language, dyslexia, diminished mental capacity, and the like.

The identification device 110 is preferably programmed with information identifying the user's information receipt and interpretation limitation(s) and may also include an identifier of a preferred format for receiving information content. The programming of the identification device 110 may be performed in any known manner, such as uploading a profile into the identification device 110 from a computer terminal, encoding the identification information onto a magnetic stripe, programming the identification information into a memory of the identification device 110, or the like.

When the user of the identification device is within the vicinity of the information content retrieval device 120, the identification information for the user may be sent to the information content retrieval device 120. This may be done in many different ways. For example, the information content retrieval device 120 or the identification device 110 may continuously broadcast a message which is receivable by the other device. In response to receiving a broadcast message from the information content retrieval device 120, the identification device 110 may transmit the identification information, for example.

Alternatively, the transmission of the identification information may be performed in response to manipulation of an input interface of the information content retrieval device 120 by a user of the identification device 110. The information content retrieval device 120 may transmit a message to the identification device 110 in response to manipulation of the input interface and then receive the identification information in response to receipt of the message by the identification device 110.

Moreover, the identification information may be read from the identification device 110 in response to the user inserting the identification device 110 or otherwise placing the identification device 110 in a position to be read by a reader device associated with the information retrieval device 120. For example, the information retrieval device 120 may be equipped with a smartcard or magnetic stripe card reader that reads the identification information when the user inserts the identification device 110 into the reader.

Additionally, the identification information may be transmitted to the information content retrieval device 120 in response to a transmission command having been entered through an input interface associated with the identification device 110. For example, if the identification device 110 is a personal digital assistant, the user may select a graphical icon representing a “transmit identification information” function. Other manners by which the identification information may be provided to the information content retrieval device 120 may be used without departing from the spirit and scope of the present invention.

In addition to the identification information, the information content retrieval device 120 may receive a selection of information content desired by the user of the identification device 110. The selection of information content may be performed via an input device associated with either the information content retrieval device 120 or the identification device 110. If the selection is input via an input interface of the identification device 110, the selection may be transmitted to the information content retrieval device 120 in a similar manner as the identification information.

Alternatively, the information content retrieval device 120 may output the same information content without allowing a user to select information content. For example, the information content retrieval device 120 may only broadcast one type of information content, yet in formats that are adaptable to the limitations of the users in the vicinity of the information content retrieval device 120. In such a case, the selection of information content may not be required of the user.

Based on the identification information received from the identification device 110, the information retrieval device determines the information receipt and interpretation limitations of the user. For example, the information content retrieval device 120 may determine from the identification information that the user is hearing impaired, blind, has limited vision, speaks a different language, or the like.

The determination of the limitations of the user may be performed based only on the identification information or may be based on a combination of the identification information and lookup information in a user profile database stored in the information content retrieval device 120. For example, if the identification information provided by the identification device 110 includes only an identifier of the user, the user identifier may be used to perform a lookup in the user profile database to identify the limitations of that user. Alternatively, the limitations of the user may be reported to the information content retrieval device 120 directly in the identification information provided by the identification device 110.

Based on the identification of the limitations of the user, a format that is best suited for these limitations may be determined. Such a format may include, for example, using only text information, using only video or graphical information, using only audio information, or any combination of these. Additionally, the format may be determined in such a way as to enhance certain portions of a standard information content while degrading other portions of the standard format. For example, audio information may be enhanced while video information is degraded. The format may be determined by the information content retrieval device 120 or may be reported to the information content retrieval device 120 by the identification device 110.

Once the identification of the user's limitations is performed and the determination of a preferred information format is made, the information content retrieval device 120 may send a request to an information source 140-160 for information content. The request may be directed to a specific information source 140-160 or may be broadcast over the network 130 in such a manner that information sources 140-160 that provide the desired information content will respond to the request.

The information sources 140-160 may provide different types of information content in various formats, may provide information content in a single format, or may provide the same type of information content in various formats. In other words, information source 140 may provide sports news information content in textual, graphical, video and audio formats while information source 150 provides entertainment programs in graphical, video and audio formats. Information source 140 may alternatively provide sports news information content in only audio format. Information source 150 may alternatively provide sports news information content in video and textual format.

Based on the preferred format for the user of the identification device 110, information content may be downloaded or streamed from an information source 140-160. In this way, the information content is provided to the user in a format that is best cognizable to the user.

In another embodiment of the present invention, each of the information sources 140-160 may provide the same standard formatted information content regardless of the preferred format for the user. In such an embodiment, the standard formatted information content is downloaded or streamed to the information content retrieval device 120 and then portions of the information content are enhance and/or degraded to thereby reformat the information content to the preferred format for the user.

For example, sports news information content may be streamed to the information content retrieval device 120 from the information source 150. The sports news information content may contain video, textual and audio information. If the user is sight impaired, the information content retrieval device 120 will degrade the video and textual aspects of the information content and may enhance the audio aspect of the information.

Enhancement of various aspects of the information content may include amplifying the output signal, increasing the bandwidth for a particular portion of the information content stream, providing additional information in that format, e.g. providing audio information that describes the video information that has been degraded, and the like. The additional information in that format may be downloaded or streamed from the same information source or a different information source. In this way, the user is provided with an enhanced information content output that is formatted to the particular needs of the user.

The information content that is formatted to the particular needs of the user may then be output by the information content retrieval device 120, the identification device 110, or the like. For example, the information content retrieval device 120 and/or identification device 110 may include a display, audio speaker, and the like, for outputting information content in various formats. The information content retrieval device 120 may output the information content directly using its own output devices or may transmit the information content to the identification device 110 for output.

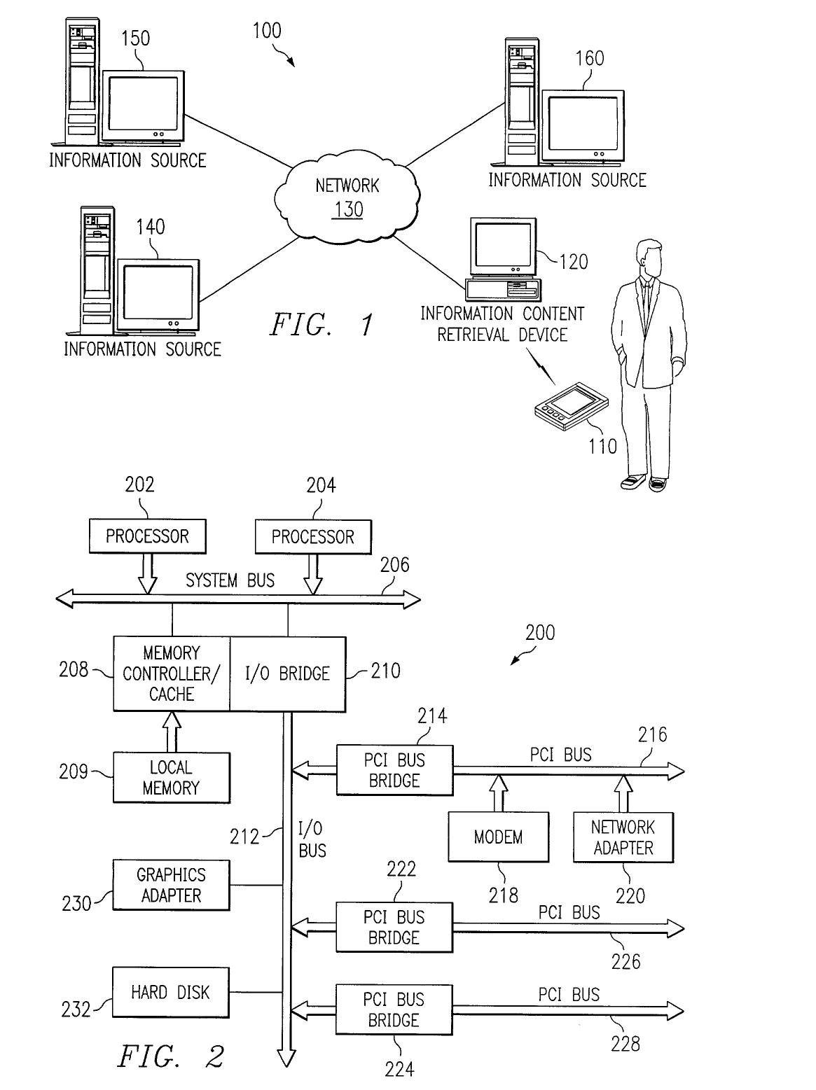

FIG. 2 is an exemplary block diagram illustrating an information source according to the present invention. Data processing system 200 may be a symmetric multiprocessor (SMP) system including a plurality of processors 202 and 204 connected to system bus 206.

Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to 1/0 bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

FIG. 3 is an exemplary block diagram illustrating an information content retrieval device according to the present invention. Data processing system 300 is an example of a client computer that is a client of the information sources of the network. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. In particular, the hardware in FIG. 3 may further include one or more transceivers for receiving identification information from the identification device 110, for example. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide nonvolatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

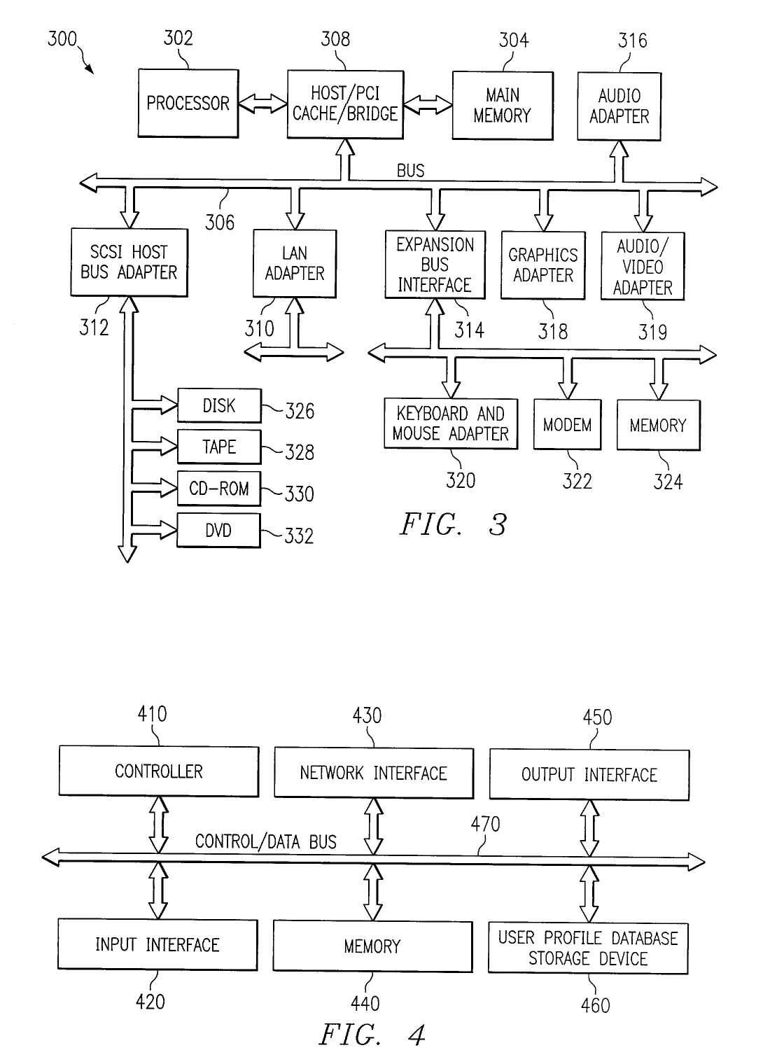

FIG. 4 is an exemplary block diagram illustrating the primary operational components of an information content retrieval device according to the present invention. The operational components described in FIG. 4 may be implemented in hardware, software, or a combination of hardware and software. In a preferred embodiment of the present invention, the operation components are implemented as software executed by one or more of the hardware devices shown in FIG. 3.

As shown in FIG. 4, the information content retrieval device includes a controller 410, an input interface 420, a network interface 430, a memory 440, an output interface 450, and a user profile storage device 460. These elements are coupled to one another via the control/data bus 470. Although a bus architecture is shown in FIG. 4, any architecture that facilitates the exchange of control messages and data between the elements 410-460 may be used without departing from the spirit and scope of the present invention.

The controller 410 controls the overall operation of the information content retrieval device. The controller 410 receives identification information from an identification device via the input interface as well as a user selection of information content, if appropriate for the particular embodiment. The controller 410 then determines the limitations of the user based on the received identification information and information stored in the user profile storage device 460 based on instructions maintained in the memory 440.

Based on the user limitations, the controller 410 issues a request message to an information source via the network interface 430. Once the requested information content is received from the information source via the network interface 430, the controller 410 may reformat the information content by enhancing and/or degrading aspects of the information content. The reformatted information content may then be provided to the user via the output interface 450.

FIG. 5 is an exemplary block diagram illustrating the primary operational components of an information source according to the present invention. The operational components described in FIG. 5 may be implemented in hardware, software, or a combination of hardware and software. In a preferred embodiment of the present invention, the operation components are implemented as software executed by one or more of the hardware devices shown in FIG. 2.

As shown in FIG. 5, the information source includes a controller 510, a network interface 520 and an information content storage device 530. These elements are coupled to one another via the control/data bus 540. Although a bus architecture is shown in FIG. 5, any architecture that facilitates the exchange of control messages and data between the elements 510-530 may be used without departing from the spirit and scope of the present invention.

The controller 510 controls the overall operation of the information source. The controller 510 receives information content requests from the information content retrieval device via the network interface 520. The controller 510 then retrieves information content from the information content storage device 530 based on the received request. The information content retrieved may be formatted according to the request received or may be a standard format information content, as described above.

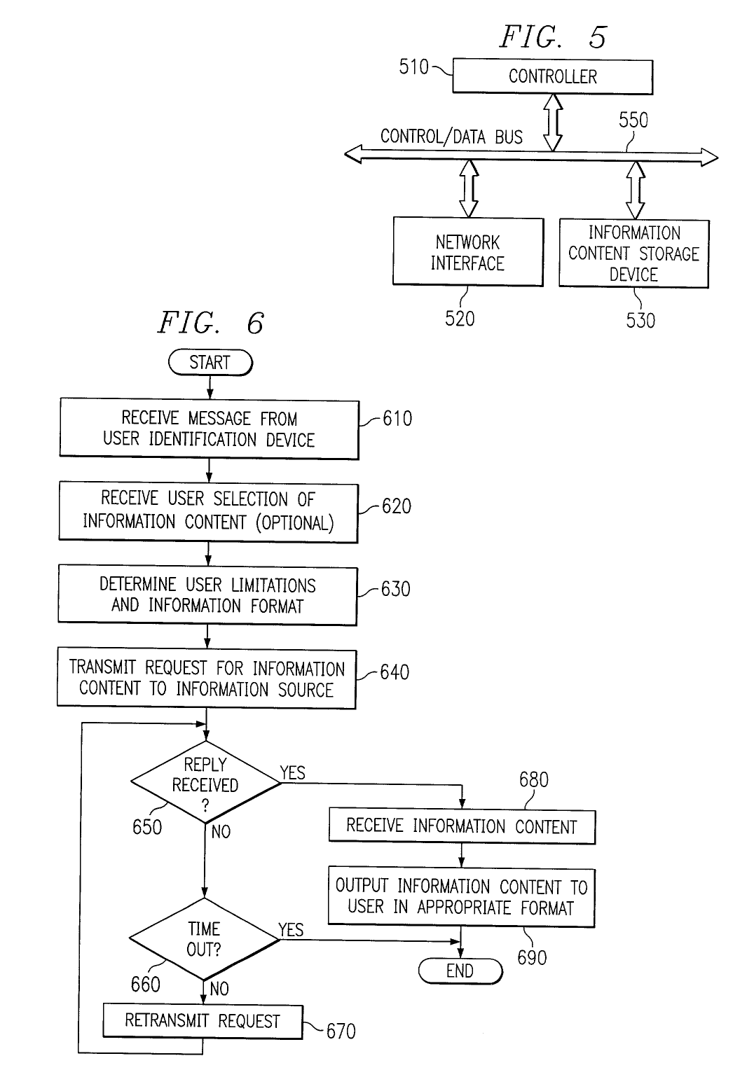

FIG. 6 is a flowchart outlining an exemplary operation of an information content retrieval device according to the present invention. As shown in FIG. 6, the operation starts with receiving identification information from an identification device (step 610). Optionally, a user selection of an information content may also be received (step 620). User limitations are then determined based on the identification information received (step 630).

A request for information content is then transmitted to an appropriate information source (step 640). A determination is made as to whether a reply to the request is received (step 650). If not, a determination is made as to whether the request has timed out (step 660). If the request has not timed out, the request is retransmitted (step 670) and the operation returns to step 650. If the request has timed out, the operation ends and an error message may be output.

If a reply message is received in response to the request message, the requested information content is received from the information source (step 680). The information content is then output to the user in an appropriate format as determined in the manner described above (step 690). The operation then ends.

Thus, the present invention provides an apparatus and method for providing information content to a user formatted for the user's particular needs. The formatting of the information content is based on limitations of the user regarding the user's ability to receive and understand the form of the information content. In this way, a user's disabilities may be taken into account when providing the user with information content. In addition, the formatting of the information may be performed in an automatic manner with little or no input necessary from the user.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for providing information content to a user, comprising:
receiving an identification of the user;
determining one or more physical limitations of the user regarding receipt and/or interpretation of the information content based on the identification of the user; and
outputting information content to the user based on the one or more physical limitations of the user.

2. The method of claim 1, wherein determining one or more physical limitations of the user includes determining a handicap of the user.

3. The method of claim 1, wherein determining one or more physical limitations of the user includes looking up an entry in a user profile database for the user.

4. The method of claim 1, wherein outputting information content to the user based on the one or more physical limitations of the user includes outputting the information content in a format that takes into consideration the physical limitations of the user.

5. The method of claim 1, wherein outputting information content to the user based on the one or more physical limitations of the user includes reformatting information content to enhance a portion of the information content.

6. The method of claim 1, wherein determining one or more physical limitations of the user includes determining if the user has one of hearing loss, loss of sight, diminished hearing, diminished sight, and speaks a foreign language.

7. The method of claim 1, further comprising receiving a selection of the information content from the user.

8. The method of claim 1, wherein the identification of the user is received from one of a wireless transmitter, an input interface, a personal digital assistant, a smartcard, a wireless transmitter, a two-way pager device, a Bluetooth™ enabled device, a wearable computer, and a magnetic stripe card.

9. The method of claim 1, wherein the information content includes at least one of textual information, graphical information, video information, and audio information.

10. The method of claim 9, wherein outputting information content to the user based on the one or more physical limitations of the user includes enhancing one or more of the textual information, graphical information, video information and audio information based on the determined physical limitations of the user.

11. The method of claim 10, wherein if the one or more physical limitations of the user includes diminished sight, the audio information is enhanced.

12. The method of claim 10, wherein if the one or more physical limitations of the user includes diminished hearing, one or more of the video information, textual information and graphical information are enhanced.

13. The method of claim 10, wherein if the one or more physical limitations of the user includes t he user speaking a foreign language, one or more of the video information and the graphical information are enhanced.

14. An apparatus for providing information content to a user, comprising:
a processor; and
an interface coupled to the processor, wherein the processor receives an identification of the user via the interface, determines one or more physical limitations of the user regarding receipt and/or interpretation of the information content based on the identification of the user, and outputs information content, via the interface, to the user based on the one or more physical limitations of the user.

15. The apparatus of claim 14, wherein the processor determines one or more physical limitations of the user by determining a handicap of the user.

16. The apparatus of claim 14, wherein the processor determines one or more physical limitations of the user by looking up an entry in a user profile database for the user.

17. The apparatus of claim 14, wherein the processor outputs information content to the user based on the one or more physical limitations of the user by outputting the information content in a format that takes into consideration the physical limitations of the user.

18. The apparatus of claim 14, wherein the processor outputs information content to the user based on the one or more physical limitations of the user by reformatting information content to enhance a portion of the information content.

19. The apparatus of claim 14, wherein the processor determines one or more physical limitations of the user by determining if the user has one of hearing loss, loss of sight, diminished hearing, diminished sight, and speaks a foreign language.

20. The apparatus of claim 14, wherein the processor receives a selection of the information content from the user via the interface.

21. The apparatus of claim 14, wherein the identification of the user is received from one of a wireless transmitter, an input interface, a personal digital assistant, a smartcard, a wireless transmitter, a two-way pager device, a Bluetooth™ enabled device, a wearable computer, and a magnetic stripe card.

22. The apparatus of claim 14, wherein the information content includes at least one of textual information, graphical information, video information, and audio information.

23. The apparatus of claim 22, wherein the processor outputs information content to the user based on the one or more physical limitations of the user by enhancing one or more of the textual information, graphical information, video information and audio information based on the determined physical limitations of the user.

24. The apparatus of claim 23, wherein if the one or more physical limitations of the user includes diminished sight, the processor enhances the audio information.

25. The apparatus of claim 23, wherein if the one or more physical limitations of the user includes diminished hearing, the processor enhances one or more of the video information, textual information and graphical information.

26. The apparatus of claim 23, wherein if the one or more physical limitations of the user includes the user speaking a foreign language, the processor enhances one or more of the video information and the graphical information.

27. A computer program product in a computer readable medium for providing information content to a user, comprising:
first instructions for receiving an identification of the user;
second instructions for determining one or more physical limitations of the user regarding receipt and/or interpretation of the information content based on the identification of the user; and
third instructions for outputting information content to the user based on the one or more physical limitations of the user.

28. The computer program product of claim 27, wherein the second instructions for determining one or more physical limitations of the user include instructions for determining a handicap of the user.

29. The computer program product of claim 27, wherein the second instructions for determining one or more physical limitations of the user include instructions for looking up an entry in a user profile database for the user.

30. The computer program product of claim 27, wherein the third instructions for outputting information content to the user based on the one or more physical limitations of the user include instructions for outputting the information content in a format that takes into consideration the physical limitations of the user.

31. The computer program product of claim 1, wherein the third instructions for outputting information content to the user based on the one or more physical limitations of the user include instructions for reformatting information content to enhance a portion of the information content.

32. The computer program product of claim 1, wherein the second instructions for determining one or more physical limitations of the user include instructions for determining if the user has one of hearing loss, loss of sight, diminished hearing, diminished sight, and speaks a foreign language.

33. The computer program product of claim 1, further comprising fourth instructions for receiving a selection of the information content from the user.

34. The computer program product of claim 1, wherein the identification of the user is received from one of a wireless transmitter, an input interface, a personal digital assistant, a smartcard, a wireless transmitter, a two-way pager device, a Bluetooth™ enabled device, a wearable computer, and a magnetic stripe card.

35. The computer program product of claim 1, wherein the information content includes at least one of textual information, graphical information, video information, and audio information.

36. The computer program product of claim 9, wherein the third instructions for outputting information content to the user based on the one or more physical limitations of the user include instructions for enhancing one or more of the textual information, graphical information, video information and audio information based on the determined physical limitations of the user.

37. The computer program product of claim 10, wherein if the one or more physical limitations of the user includes diminished sight, the audio information is enhanced.

38. The computer program product of claim 10, wherein if the one or more physical limitations of the user includes diminished hearing, one or more of the video information, textual information and graphical information are enhanced.

39. The computer program product of claim 10, wherein if the one or more physical limitations of the user includes t he user speaking a foreign language, one or more of the video information and the graphical information are enhanced.
